(19) United States
(12) Patent Application Publication
(10) Pub. No.: US 2020/0399403 A1
(43) Pub. Date: Dec. 24, 2020

(54) Wheat Straw Pulp, Preparation Method Therefor, Application Thereof and Method for Adjusting Degree of Substitution of CMC

(71) Applicant: NANJING FORESTRY UNIVERSITY, Nanjing (CN)

(72) Inventors: Hao Ren, Nanjing (CN); Zhang Feng, Nanjing (CN); Huamin Zhai, Nanjing (CN)

(73) Assignee: NANJING FORESTRY UNIVERSITY, Nanjing (CN)

(21) Appl. No.: 16/977,754

(22) PCT Filed: Jan. 6, 2020
(86) PCT No.: PCT/CN2020/070528

§ 371 Date: Sep. 2, 2020

(30) Foreign Application Priority Data
Nov. 28, 2018 (CN) 201811432220.6

(51) Int. Cl. C08B 11/12; D21B 1/30; D21H 11/12

(52) U.S. Cl. CPC C08B 11/12; D21H 11/12; D21B 1/303

(57) ABSTRACT

A wheat straw pulp, a preparation method therefor, an application thereof, and a method for adjusting the degree of substitution of CMC. The preparation method for the wheat straw pulp comprises the following steps: using water as a medium, performing ultrasonic crushing on wheat straw, performing solid-liquid separation, and collecting the solid to obtain wheat straw pulp, the temperature of the ultrasonic crushing being 25-100° C. In the preparation method, by using water as a medium, wheat straw is dissociated into wheat straw fibers in water in a mild temperature condition by means of ultrasonic crushing accompanied by H2O2. The wheat straw pulp can be used for preparing CMC. By adjusting different technological conditions to adjust the properties of the wheat straw pulp, CMC having different degrees of substitution can be prepared.

### CROSS-REFERENCE TO RELATED APPLICATIONS

The present application claims the priority of Chinese Patent Application No. 201811432220.6 filed with the Chinese Patent Office on Nov. 28, 2018 and entitled “Wheat Straw Pulp, Preparation Method Therefor, Application Thereof and Method for Adjusting Degree of Substitution of CMC”, the entire content of which is incorporated herein by reference.

### TECHNICAL FIELD

The present disclosure relates to the technical field of carboxymethyl cellulose, in particular to a wheat straw pulp, a preparation method and an application thereof, and a method for adjusting the substitution degree of CMC.

### BACKGROUND

Carboxymethyl cellulose, referred to as CMC for short, is a water-soluble ionic cellulose ether obtained by chemically modifying natural cellulose as a basic raw material. Carboxymethyl cellulose has the characteristics of thickening, shaping, emulsifying, dispersing, water retention, acid resistance, salt resistance, etc., and is harmless. Therefore, it has been widely used in fields of food, medicine, papermaking, textile, etc.

In existing methods for preparing carboxymethyl cellulose, refined cotton made of cotton linters is often used as the raw material, which causes a problem of high raw material cost. And serious pollution caused by wastewater and the like in the production of refined cotton is not conducive to energy conservation and environmental protection. When wheat straw or other plant fibers are used as raw materials to prepare carboxymethyl cellulose, chlorine-containing reagents (such as ClO₂ and the like) are usually used to remove lignin from plant fibers, which pollutes water bodies and has high environmental costs. Therefore, it is of great significance to develop a new raw material suitable for the preparation of carboxymethyl cellulose.

### SUMMARY

The present disclosure provides a method for preparing a wheat straw pulp, comprising the following steps:
subjecting wheat straws to ultrasonic crushing treatment using water as a medium, followed by solid-liquid separation, and collecting solids to obtain the wheat straw pulp, wherein the ultrasonic crushing treatment is performed at a temperature of 25-100° C.

In one or more embodiments, NaOH is added to the water for the ultrasonic crushing treatment of the wheat straws.

In one or more embodiments, a mass fraction (weight fraction) of NaOH in water is 0.1-1.5%.

In one or more embodiments, a mass fraction of NaOH in water is 0.5-1.5%.

In one or more embodiments, H₂O₂ is added to the medium during the ultrasonic crushing treatment.

In one or more embodiments, the mass (weight) of added H₂O₂ is 2-8% of the mass of the wheat straws.

In one or more embodiments, the mass of added H₂O₂ is 3-7% of the mass of the wheat straws.

In one or more embodiments, after the ultrasonic crushing treatment, the temperature is raised to 100-130° C., and then maintained for 10-15 min, followed by solid-liquid separation, and collecting solids to obtain the wheat straw pulp.

In one or more embodiments, the ultrasonic crushing treatment is conducted for 2-10 min.

In one or more embodiments, the ultrasonic crushing treatment is conducted for 3-8 min.

In one or more embodiments, a mass ratio of the wheat straws to the water is 1:(3-6).

In one or more embodiments, a mass ratio of the wheat straws to the water is 1:(4-5).

In one or more embodiments, the ultrasonic crushing treatment is conducted at a temperature of 50-70° C. for 3-5 min, and a mass fraction of NaOH in the medium is 0.5-0.8%.

In one or more embodiments, the ultrasonic crushing treatment is conducted at a temperature of 70-80° C. for 5-8 min, and a mass fraction of NaOH in the medium is 0.8-1%.

In one or more embodiments, the ultrasonic crushing treatment is conducted at a temperature of 80-100° C. for 5-8 min, and a mass fraction of NaOH in the medium is 1-1.5%.

In one or more embodiments, the ultrasonic crushing treatment is conducted at a temperature of 80-100° C. for 5-8 min, and the mass of added H₂O₂ is 3-5% of the mass of the wheat straws.

In one or more embodiments, the ultrasonic crushing treatment is conducted at a temperature of 25-30° C. for 5-8 min, the mass of added H₂O₂ is 3-5% of the mass of the wheat straws, and after the ultrasonic crushing treatment, the temperature is raised to 100-110° C., and maintained for 10-15 min.

In one or more embodiments, the ultrasonic crushing treatment is conducted at a temperature of 25-30° C. for 5-8 min, the mass of added H₂O₂ is 5-7% of the mass of the wheat straws, and after the ultrasonic crushing treatment, the temperature is raised to 100-130° C., and maintained for 10-15 min.

In one or more embodiments, the ultrasonic crushing treatment is conducted under conditions: an ultrasonic power being 1100-3300 W, and an ultrasonic frequency being 20-40 kHz.

In one or more embodiments, the ultrasonic power is 1500-3000 W, and the ultrasonic frequency is 25-35 kHz.

The present disclosure provides a wheat straw pulp prepared according to the method for preparing a wheat straw pulp of the present disclosure.

In one or more embodiments, the wheat straw pulp has a whiteness of 40-86%.

The present disclosure provides an application of the wheat straw pulp of the present disclosure in the preparation of carboxymethyl cellulose.

In one or more embodiments, a method for preparing the carboxymethyl cellulose comprises: dispersing the wheat straw pulp in isopropanol, adding sodium hydroxide and chloroacetic acid to obtain a mixture, stirring the mixture at a temperature of 50-60° C. for reaction for 4-12 h, collecting solids, and washing and drying the solids to obtain the carboxymethyl cellulose.

In one or more embodiments, a mass ratio of the wheat straw pulp to the isopropanol is 1:(30-120).

In one or more embodiments, a mass ratio of the wheat straw pulp, sodium hydroxide and chloroacetic acid is 1:(0.5-1.2):(0.6-3).

In one or more embodiments, carboxymethyl celluloses, which have different substitution degrees are obtained by adjusting concentration of NaOH in the medium, duration and temperature of the ultrasonic crushing treatment of the wheat straw, and amount (mass) of the added H₂O₂.

In one or more embodiments, a mass fraction of NaOH in the medium is 0.1-1.5%, the duration of the ultrasonic crushing treatment is 2-10 min, the temperature of the ultrasonic crushing treatment is 25-100° C., and the mass of added H₂O₂ is 0-8% of the mass of the wheat straw.

In one or more embodiments, when the wheat straw pulp used as a raw material is prepared under conditions that the ultrasonic crushing treatment is performed at a temperature of 50-70° C. for 3-5 min, a mass fraction of NaOH in the medium is 0.5-0.8%, and amount of added H₂O₂ is 0, the carboxymethyl cellulose has a substitution degree of 0.52-0.68.

In one or more embodiments, when the wheat straw pulp used as a raw material is prepared under conditions that the ultrasonic crushing treatment is performed at a temperature of 70-80° C. for 5-8 min, a mass fraction of NaOH in the medium is 0.8-1%, and amount of added H₂O₂ is 0, the carboxymethyl cellulose has a substitution degree of 0.68-0.79.

In one or more embodiments, when the wheat straw pulp used as a raw material is prepared under conditions that the ultrasonic crushing treatment is performed at a temperature of 80-100° C. for 5-8 min, a mass fraction of NaOH in the medium is 1-1.5%, and amount of added H₂O₂ is 0, the carboxymethyl cellulose has a substitution degree of 0.76-0.98.

In one or more embodiments, when the wheat straw pulp used as a raw material is prepared under conditions that the ultrasonic crushing treatment is performed at a temperature of 80-100° C. for 5-8 min, a mass fraction of NaOH in the medium is 0.8-1%, and a mass of added H₂O₂ is 3-5% of the mass of the wheat straw, the carboxymethyl cellulose has a substitution degree of 0.90-1.02.

In one or more embodiments, when the wheat straw pulp used as a raw material is prepared under conditions that the ultrasonic crushing treatment is performed at a temperature of 25-30° C. for 5-8 min, a mass fraction of NaOH in the medium is 1-1.5%, a mass of added H₂O₂ is 3-5% of the mass of the wheat straw, the temperature is raised to 100-110° C. after the ultrasonic crushing treatment and maintained for 10-15 min, the carboxymethyl cellulose has a substitution degree of 0.88-1.23.

In one or more embodiments, when the wheat straw pulp used as a raw material is prepared under conditions that the ultrasonic crushing treatment is performed at a temperature of 25-30° C. for 5-8 min, a mass fraction of NaOH in the medium is 1-1.5%, a mass of added H₂O₂ is 5-7% of the mass of the wheat straw, the temperature is raised to 100-130° C. after the ultrasonic crushing treatment and maintained for 10-15 min, the carboxymethyl cellulose has a substitution degree of 1.18-1.67.

The present disclosure provides a method for preparing carboxymethyl cellulose, comprising:
a) preparing a wheat straw pulp according to the method for preparing a wheat straw pulp described herein; and
b) making the wheat straw pulp in contact with a free base and an etherifying agent in a reaction medium.

In one or more embodiments, the free base is NaOH.

In one or more embodiments, the etherifying agent is chloroacetic acid.

In one or more embodiments, the reaction medium is water or an organic solvent.

In one or more embodiments, the organic solvent is at least one selected from the group consisting of ethanol, propanol, butanol, and acetone.

In one or more embodiments, the organic solvent is isopropanol.

In one or more embodiments, step b) is performed at 20-90° C.

In one or more embodiments, step b) is performed at 50-60° C.

In one or more embodiments, the method further comprises collecting solids, washing and/or drying the collected solids.

In one or more embodiments, a mass ratio of the wheat straw pulp to the reaction medium is 1:(30-120).

In one or more embodiments, a mass ratio of the wheat straw pulp, the free base and the etherifying agent is 1:(0.5-1.2) : (0.6-3).

### DETAILED DESCRIPTION OF EMBODIMENTS

The technical solutions of the present disclosure will be described clearly and completely in combination with specific embodiments below, but those skilled in the art will understand that the embodiments described below are part of the embodiments of the present disclosure, but not all of them, and are only used for illustration of the present disclosure and should not be considered as limiting the scope of the disclosure. Based on the embodiments in the present disclosure, all other embodiments obtained by those ordinarily skilled in the art without using creative efforts shall fall within the protection scope of the present disclosure. If the specific conditions are not indicated in the examples, conditions which are the conventional or recommended by the manufacturer are used. If the manufacturers of the reagents or instruments used are not specified, the reagents or instruments are conventional and commercially available products.

Unless otherwise defined herein, scientific and technical terms used in connection with the present disclosure shall have meanings as commonly understood by those ordinarily skilled in the art. Exemplary methods and materials are described below, but methods and materials similar or equivalent to those described herein can also be used in the practice or testing of the present disclosure.

As used herein, the term “wheat straw pulp” generally refers to a pulp of cellulosic fibers chemically or physically separated from wheat straws.

As used herein, the term “wheat straw” generally refers to wheat straws.

The term “substitution degree of carboxymethyl cellulose” or “substitution degree” refers to how many the hydrogen atoms of the hydroxyl groups in each glucose unit in carboxymethyl cellulose is replaced by carboxymethyl group(s). As known to those skilled in the art, one glucose unit of carboxymethyl cellulose has three hydroxyl groups. Thus, for example, a substitution degree of 3 means that hydrogen atoms on all three hydroxyl groups of each glucose unit in carboxymethyl cellulose are replaced by carboxymethyl groups. It is generally believed that the emulsification performance is relatively better when the substitution degree is around 0.6-0.7, and other properties are improved correspondingly as the substitution degree increases. When the substitution degree of carboxymethyl cellulose is greater than 0.8, acid resistance and salt resistance thereof are significantly enhanced.

As used herein, “whiteness of wheat straw pulp” or “whiteness” refers to the degree of whitening or bleaching of wheat straw pulp, which is essentially the total reflectance of wheat straw pulp to light, expressed as a percentage (%) or degree. For example, GB 8940.2 is used to express whiteness herein.

The purpose of one or more embodiments of the present disclosure includes, for example, providing a method for preparing wheat straw pulp. The wheat straw pulp obtained by the preparation method can be used as a raw material for preparing carboxymethyl cellulose, with environmentally friendly production process and low cost.

The purpose of one or more embodiments of the present disclosure includes, for example, providing a wheat straw pulp prepared by the above method. The wheat straw pulp is used as a raw material for the preparation of carboxymethyl cellulose, with low cost of raw materials.

The purpose of one or more embodiments of the present disclosure includes, for example, providing an application of the wheat straw pulp of the present disclosure in preparation of carboxymethyl cellulose. The carboxymethyl celluloses with different degrees of substitution may be prepared by controlling different process conditions to adjust properties of carboxymethyl celluloses, which meets the needs of application in different fields, and solves the problem that the carboxymethyl cellulose product prepared by other methods in the prior art has a single substitution degree and cannot adapt to multiple fields.

The purpose of one or more embodiments of the present disclosure includes, for example, providing a method for adjusting the substitution degree of CMC. By adjusting the process parameters (including the duration and temperature of ultrasonic treatment and the amount of added H₂O₂) of preparation process of the wheat straw pulp, wheat straws are dissociated to different degrees and the degree of delignification is controlled. Therefore, carboxymethyl cellulose products with different substitution degrees are obtained by controlling raw materials, to meet the needs of application in different fields.

The present disclosure provides a method for preparing wheat straw pulp, comprising the following steps:

subjecting wheat straws to ultrasonic crushing treatment using water as a medium, followed by solid-liquid separation, and collecting solids to obtain the wheat straw pulp, wherein the ultrasonic crushing treatment is performed at 25-100° C.

In one or more embodiments, the ultrasonic crushing treatment is performed at 30-95° C., 35-90° C., 40-85° C., 45-80° C., 50-75° C., 55-70° C., or 60-65° C.

In the prior art, wheat straw pulp is prepared by placing wheat straw in a strong alkaline solution and cooking under certain conditions for 2-3 hours, which not only consumes a large amount of chemicals, consumes large amounts of steam, has low efficiency, and has serious pollution due to wastewater discharge, but also destroys carbohydrate fiber due to chemicals and reduces pulping rate.

In the present disclosure, wheat straws are dissociated into wheat straw fibers in water or a weak alkaline solution, with energy generated by forming and exploding air bubbles via subjecting water medium to ultrasonic energy during ultrasonic crushing treatment using water as medium under mild temperature conditions. Water is used as a medium in the whole process, and for low-whiteness products, it is not necessary to add NaOH, and to add NaCl₂ in the whole process, with environmental friendliness and low cost.

In one or more embodiments, after the ultrasonic crushing treatment, the temperature is raised to 100-130° C., then maintained for 10-15 min, followed by solid-liquid separation, and collecting solids to obtain the wheat straw pulp. The temperature of more than 100° C. is achieved under appropriately increased pressure. For example, after ultrasonic crushing treatment under a normal pressure, required temperature is achieved by raising temperature in a reaction kettle with a pressure of 1 atm.

In one or more embodiments, NaOH is added to the water for the ultrasonic crushing treatment of the wheat straws. In one or more embodiments, the mass fraction of NaOH in water is 0.1-1.5%, such as 0.5-1.5%.

In one or more embodiments, the mass fraction of NaOH in water is 0.3-1.3%, 0.4-1.2%, 0.5-1.1%, 0.6-1.0%, 0.7-0.9%, or 0.8%.

In one or more embodiments, H₂O₂ is added to the medium during the ultrasonic crushing treatment process. In the present disclosure, a whiteness of the resulting wheat straw pulp may be adjusted, to meet different requirements, by adding H₂O₂ into water or diluted NaOH solution and adjusting pH of the water system in combination of suitable ultrasonic crushing treatment conditions during ultrasonic crushing treatment of the wheat straws. There is no residue of H₂O₂ in the resulting wheat straw pulp, which thus is natural and environmentally friendly.

In one or more embodiments, the mass of added H₂O₂ is 2-8%, such as 3-7%, of the mass of the wheat straws. By adjusting the amount of added H₂O₂ and the pH of the aqueous medium in combination of ultrasonic crushing treatment, the wheat straws can be dissociated (degraded) to different degrees, and the degree of delignification can be controlled, thus controlling the whiteness of the wheat straw pulp. By regulating the amount of H₂O₂ within the above range, while effective removal of lignin is ensured, the damage to the fiber structure is avoided and the quality of wheat straw pulp is improved.

In one or more embodiments, the ultrasonic crushing treatment is conducted for 2-10 min, such as 3-8 min. By adjusting the duration as well as temperature of ultrasonic crushing treatment, wheat straw pulps with different whiteness were obtained. The preparation of wheat straw pulp according to the present disclosure can be completed in only a few minutes, and has high timeliness, energy saving and environmental protection, compared with the existing cooking for many hours.

In one or more embodiments, the ultrasonic crushing treatment is conducted for 3-9 min, 3.5-8.5 min, 4-8 min, 4.5-7.5 min, 5-7 min or 6 min.

In one or more embodiments, a mass ratio of the wheat straws to the water medium is 1:(3-6), e.g., 1:(4-5) or 1:(4-4.5).

In one or more embodiments, the ultrasonic crushing treatment is conducted at a temperature of 50-70° C. for 3-5 min, and a mass fraction of NaOH in the medium is 0.5-0.8%.

In one or more embodiments, the ultrasonic crushing treatment is conducted at a temperature of 70-80° C. for 5-8 min, and a mass fraction of NaOH in the medium is 0.8-1%.

In one or more embodiments, the ultrasonic crushing treatment is conducted at a temperature of 80-100° C. for 5-8 min, and a mass fraction of NaOH in the medium is 1-1.5%.

In one or more embodiments, the ultrasonic crushing treatment is conducted at a temperature of 80-100° C. for 5-8 min, a mass fraction of NaOH in the medium is 0.8-1%, and the mass of added H₂O₂ is 3-5% of the mass of the wheat straws.

In one or more embodiments, the ultrasonic crushing treatment is conducted at a temperature of 25-30° C. for 5-8 min, a mass fraction of NaOH in the medium is 1-1.5%, the mass of added H₂O₂ is 3-5% of the mass of the wheat straws, and after the ultrasonic crushing treatment, the temperature is raised to 100-110° C., and maintained for 10-15 min.

In one or more embodiments, the ultrasonic crushing treatment is conducted at a temperature of 25-30° C. for 5-8 min, a mass fraction of NaOH in the medium is 1-1.5% the mass of added H₂O₂ is 5-7% of the mass of the wheat straws, and after the ultrasonic crushing treatment, the temperature is raised to 100-130° C., and maintained for 10-15 min.

In the present disclosure, degrees of dissociation and delignification of wheat straws are controlled by adjusting conditions of the ultrasonic crushing treatment, including duration, temperature, adding of NaOH or not, adding of H₂O₂ or not, and amount of H₂O₂ if added, to obtain wheat straw pulps with various whiteness. For example, in the case that the ultrasonic crushing treatment is performed at a temperature of 50-70° C. for 3-5 min, the mass fraction of NaOH in the medium is 0.5-0.8% and the H₂O₂ is not added, the whiteness of the obtained wheat straw pulp is 40-50%; in the case that the ultrasonic crushing treatment is performed at a temperature of 70-80° C. die 5-8 min, the mass fraction of NaOH in the medium is 0.8-1%, and the H₂O₂ is not added, the whiteness of the obtained wheat straw pulp is 50-60%; in the case that the ultrasonic crushing treatment is performed at a temperature of 80-100° C. for 5-8 min, the mass fraction of NaOH in the medium is 1-1.5%, and the H₂O₂ is not added, the whiteness of the obtained wheat straw pulp is 58-68%; in the case that the ultrasonic crushing treatment is performed at a temperature of 80-100° C. for 5-8 min, the mass fraction of NaOH in the medium is 0.8-1%, and the mass of the added H₂O₂ is 3-5% of the mass of the wheat straws, the whiteness of the obtained wheat straw pulp is 70-80%; in the case that the ultrasonic crushing treatment is performed at a temperature of 25-30° C. for 5-8 min, the mass fraction of NaOH in the medium is 1-1.5%, the mass of the added H₂O₂ is 3-5% of the mass of the wheat straws, the temperature of the system is raised after the ultrasonic crushing treatment to 100-110° C. under a pressure of 1 atm, and the temperature is maintained at the highest point for 10-15 min, the whiteness of the obtained wheat straw pulp is 75-85%; in the case that the ultrasonic crushing treatment is performed at a temperature of 25-30° C. for 5-8 min, the mass fraction of NaOH in the medium is 1-1.5%, the mass of the added H₂O₂ is 5-7% of the mass of the wheat straws, the temperature of the system is raised after the ultrasonic crushing treatment to 100-130° C. under a pressure of 1 atm, and the temperature is maintained at the highest point for 10-15 min, the whiteness of the obtained wheat straw pulp is 80-86%.

In one or more embodiments, the ultrasonic crushing treatment is conducted under conditions: an ultrasonic power being 1100-3300 W, and an ultrasonic frequency being 20-40 kHz. The ultrasonic power and frequency can be arbitrarily selected within the above ranges. In one or more embodiments, the ultrasonic crushing treatment is conducted under conditions: an ultrasonic power being 1500-3000 W, and an ultrasonic frequency being 25-35 kHz. In one or more embodiments, the ultrasonic crushing treatment is conducted under conditions: an ultrasonic power being 2000 W, and an ultrasonic frequency being 30 kHz.

In one or more embodiments, the ultrasonic power is 1200-3200 W, 1300-3100 W, 1400-3000 W, 1500-2900 W, 1600-2800 W, 1700-2700 W, 1800-2600 W, 1900-2500 W, 2000-2400 W, 2100 -2300 W, or 2200 W.

In one or more embodiments, the ultrasound frequency is 24-36 kHz, 25-35 kHz, 26-34 kHz, 27-33 kHz, 28-32 kHz, or 29-31 kHz.

In one or more embodiments, after the solid-liquid separation, the solid is washed with water and dried to obtain the wheat straw pulp. Impurities adsorbed on the fiber surface are removed by water washing.

The present disclosure also provides a wheat straw pulp prepared by the above method. According to different process conditions, the whiteness of the wheat straw pulp is 40-86%.

In one or more embodiments, the whiteness of the obtained wheat straw pulp is 43-83%, 46-80%, 49-77%, 52-74%, 55-71%, 58-68%, 61 -65%, or 63-64%.

The present disclosure also provides an application of the above wheat straw pulp, which can be used for preparing carboxymethyl cellulose.

In one or more embodiments, a method for preparing the carboxymethyl cellulose comprises: dispersing the wheat straw pulp in isopropanol, adding sodium hydroxide and chloroacetic acid to obtain a mixture, stirring the mixture at a temperature of 50-60° C. for reaction for 4-12 h, collecting solids from the reaction, and washing and drying the solids to obtain the carboxymethyl cellulose.

In one or more embodiments, a mass ratio of wheat straw pulp to isopropanol is 1:(30-120), such as 1:(50-100). The ratio of wheat straw pulp to isopropanol can be any ratio within the above range, and can be adjusted according to actual needs. For example, in different embodiments, the mass ratio of wheat straw pulp to isopropanol can be 1:30, 1:40, 1:50, 1:60, 1:70, 1:80, 1:90, 1:100, 1:110, 1:120, etc.

In one or more embodiments, a mass ratio of the wheat straw pulp, sodium hydroxide and chloroacetic acid is 1:(0.5-1.2):(0.6-3). The mass ratio of wheat straw pulp, sodium hydroxide and chloroacetic acid can be any ratio within the above range, and can be adjusted according to actual needs.

In one or more embodiments, a method for the washing includes: first washing with a mixed solution of water and methanol for 3-5 times, and then washing with methanol for 2-3 times.

In one or more embodiments, a method of the drying includes air drying and then completely drying.

The present disclosure also provides a method for adjusting the substitution degree of carboxymethyl cellulose, wherein the substitution degree of carboxymethyl cellulose is adjusted by adjusting whiteness of wheat straw pulp.

In one or more embodiments, carboxymethyl celluloses with different substitution degrees are obtained by adjusting concentration of NaOH in the medium, duration and temperature of the ultrasonic crushing treatment of the wheat straw, and amount (mass) of the added H₂O₂.

In one or more embodiments, the ultrasonic crushing treatment is performed at a temperature of 25-100° C. for 2-10 min, and the mass of added H₂O₂ is 0-8% of the mass of the wheat straw.

In one or more embodiments, the mass of added H₂O₂ is 0.5-7.5%, 1-7%, 1.5-6.5%, 2-6%, 2.5-5.5%, 3-5%, 3.5-4.5% or 4% of the mass of the wheat straw.

In one or more embodiments, when the wheat straw pulp used as a raw material is prepared under conditions that the ultrasonic crushing treatment is performed at a temperature of 50-70° C. for 3-5 min, a mass fraction of NaOH in the medium is 0.5-0.8%, and amount of added H₂O₂ is 0, the carboxymethyl cellulose has a substitution degree of 0.52-0.68. In one or more embodiments, when the wheat straw pulp used as a raw material is prepared under conditions that the ultrasonic crushing treatment is performed at a temperature of 70-80° C. for 5-8 min, a mass fraction of NaOH in the medium is 0.8-1%, and amount of added H₂O₂ is 0, the carboxymethyl cellulose has a substitution degree of 0.68-0.79. In one or more embodiments, when the wheat straw pulp used as a raw material is prepared under conditions that the ultrasonic crushing treatment is performed at a temperature of 80-100° C. for 5-8 min, a mass fraction of NaOH in the medium is 1-1.5%, and amount of added H₂O₂ is 0, the carboxymethyl cellulose has a substitution degree of 0.76-0.98. In one or more embodiments, when the wheat straw pulp used as a raw material is prepared under conditions that the ultrasonic crushing treatment is performed at a temperature of 80-100° C. for 5-8 min, a mass fraction of NaOH in the medium is 0.8-1%, and a mass of added H₂O₂ is 3-5% of the mass of the wheat straw, the carboxymethyl cellulose has a substitution degree of 0.90-1.02. In one or more embodiments, when the wheat straw pulp used as a raw material is prepared under conditions that the ultrasonic crushing treatment is performed at a temperature of 25-30° C. for 5-8 min, a mass fraction of NaOH in the medium is 1-1.5%, a mass of added H₂O₂ is 3-5% of the mass of the wheat straw, and the temperature is raised to 100-110° C. after the ultrasonic crushing treatment and maintained for 10-15 min, the carboxymethyl cellulose has a substitution degree of 0.88-1.23. In one or more embodiments, when the wheat straw pulp used as a raw material is prepared under conditions that the ultrasonic crushing treatment is performed at a temperature of 25-30° C. for 5-8 min, a mass fraction of NaOH in the medium is 1-1.5%, a mass of added H₂O₂ is 5-7% of the mass of the wheat straw, and the temperature is raised to 100-130° C. after the ultrasonic crushing treatment and maintained for 10-15 min, the carboxymethyl cellulose has a substitution degree of 1.18-1.67.

In the disclosure, by adjusting the parameters (including the concentration of NaOH, the duration and temperature of ultrasonic treatment and the amount of the added H₂O₂) of preparation process of the wheat straw pulp, wheat straws are dissociated to different degrees and the degree of delignification is controlled, such that carboxymethyl cellulose products with different substitution degrees are obtained, meeting the needs of application in different fields. One or more embodiments of the present disclosure solve problems in the preparation method of the prior art that the substitution degree of carboxymethyl cellulose cannot be adjusted according to actual needs and that it is difficult to obtain carboxymethyl cellulose with high substitution degree. For example, the substitution degree DS of carboxymethyl cellulose used in industrial drilling, ceramics, detergents, and building materials is 0.6-0.9, the substitution degree DS of food grade carboxymethyl cellulose is usually 1-1.2, and higher substitution degree of carboxymethyl cellulose can be used in the fields of textile, printing and dyeing, etc.

The present disclosure provides a method for preparing carboxymethyl cellulose, comprising:
a) preparing a wheat straw pulp according to the method for preparing a wheat straw pulp described herein; and
b) making the wheat straw pulp in contact with a free base and an etherifying agent in a reaction medium.

In one or more embodiments, the free base is NaOH.

In one or more embodiments, the etherifying agent is chloroacetic acid.

In one or more embodiments, the reaction medium is water or an organic solvent.

In one or more embodiments, the organic solvent is at least one selected from the group consisting of ethanol, propanol, butanol, and acetone.

In one or more embodiments, the organic solvent is isopropanol.

In one or more embodiments, the step b) is performed at 20-90° C., for example, 30-80° C., 35-80° C., 40-75° C., 45-70° C., 50-65° C., or 55-60° C.

In one or more embodiments, the method further comprises collecting solids, washing and/or drying the collected solids.

In one or more embodiments, a mass ratio of the wheat straw pulp to the reaction medium is 1:(30-120), such as 1:(35-115), 1:(40-110), 1:(45 -105), 1:(50-100), 1:(55-95), 1:(60-90), 1:(65-85), 1:(70-80), or 1:75.

In one or more embodiments, the mass ratio of the wheat straw pulp, the free base and the etherifying agent is 1:(0.5-1.2):(0.6-3), such as 1:(0.6-1.1).):(0.6-3), 1:(0.7-1.0):(0.6-3), 1:(0.8-0.9):(0.6-3), 1:(0.5-1.2):(0.8-2.8), 1:(0.5-1.2):(1.0-2.6), 1:(0.5-1.2):(1.2-2.4), 1:(0.5-1.2):(1.4-2.2), 1:(0.5-1.2):(1.6-2.0), or 1:(0.5-1.2):(1.7-1.9).

Compared with the prior art, the beneficial effects of the present disclosure include at least:
(1) in the method for preparing a wheat straw pulp of the present disclosure, the ultrasonic crushing treatment is preformed using water as a medium, wherein small amounts of H₂O₂ and NaOH are added to adjust pH, so as to adjust the degree of delignification, and thus to provide wheat straw pulps with various whiteness, which production process is environmentally friendly and low-cost;
(2) by using the wheat straw pulp of the present disclosure as a raw material to prepare carboxymethyl cellulose, carboxymethyl cellulose with different substitution degrees can be obtained, so as to meet application requirements in different fields; and
(3) by adjusting the process parameters (including the concentration of NaOH, the duration and temperature of ultrasonic treatment and the amount of the added H₂O₂) in the preparation process of the wheat straw pulp, wheat straws are dissociated to different degrees and the degree of delignification is controlled, so that carboxymethyl cellulose products with different substitution degrees in a range of 0.52-1.67 are obtained, the substitution degree of carboxymethyl cellulose can be adjusted according to actual needs.

### EXAMPLE 1

The method for preparing a wheat straw pulp of the present Example included the following steps:
(1) adding 300 g of wheat straw to 1.2 L of water, followed by adding NaOH to the water until the mass concentration of NaOH is 1% to obtain a mixture, performing ultrasonic crushing treatment on the mixture at 25° C. for 8 min in an ultrasonic cell disruption device, wherein during the ultrasonic crushing treatment, 21 g of H₂O₂ was added to the water medium, then transferring the reaction system to a high-pressure reaction kettle for reaction at 1 atm and 130° C. for 15 min to obtain a reaction mixture, wherein the ultrasonic conditions were: 2000 W of ultrasonic power and 30 kHz of ultrasonic frequency; and
(2) after the treatment in step (1) was completed, performing solid-liquid separation on the reaction mixture, washing the solid part with water, and collecting and drying the solid part to obtain the wheat straw pulp, with a pulping yield of 49%.

### EXAMPLE 2

The method for preparing a wheat straw pulp of the present Example included the following steps:
(1) adding 300 g of wheat straw to 1.2 L of water, followed by adding NaOH to the water until the mass concentration of NaOH was 1% to obtain a mixture, performing ultrasonic crushing treatment on the mixture at 25° C. for 5 min in an ultrasonic cell disruption device, wherein during the ultrasonic crushing treatment, 15 g of H₂O₂ was added to the water medium, then transferring the reaction system to a high-pressure reaction kettle for reaction at 1 atm and 100° C. for 15 min to obtain a reaction mixture, wherein the ultrasonic conditions were: 2000 W of ultrasonic power and 30 kHz of ultrasonic frequency; and
(2) after the treatment in step (1) was completed, performing solid-liquid separation on the reaction mixture, washing the solid part with water, and collecting and drying the solid part to obtain the wheat straw pulp, with a pulping yield of 55%.

### EXAMPLE 3

The method for preparing a wheat straw pulp of the present Example included the following steps:
(1) adding 300 g of wheat straw to 1.2 L of water, followed by adding NaOH to the water until the mass concentration of NaOH was 1% to obtain a mixture, performing ultrasonic crushing treatment on the mixture at 25° C. for 6 min in an ultrasonic cell disruption device, wherein during the ultrasonic crushing treatment, 18 g of H₂O₂ was added to the water medium, then transferring the reaction system to a high-pressure reaction kettle for reaction at 1 atm and 121° C. for 10 min to obtain a reaction mixture, wherein the ultrasonic conditions were: 2000 W of ultrasonic power and 30 kHz of ultrasonic frequency; and
(2) after the treatment in step (1) was completed, performing solid-liquid separation on the reaction mixture, washing the solid part with water, and collecting and drying the solid part to obtain the wheat straw pulp, with a pulping yield of 51%.

### EXAMPLE 4

The method for preparing a wheat straw pulp of the present Example included the following steps:
(1) adding 300 g of wheat straw to 1.2 L of water, followed by adding NaOH to the water until the mass concentration of NaOH was 1% to obtain a mixture, performing ultrasonic crushing treatment on the mixture at 25° C. for 8 min in an ultrasonic cell disruption device wherein during the ultrasonic crushing treatment, 15 g of H₂O₂ was added to the water medium, then transferring the reaction system to a high-pressure reaction kettle for reaction at 1 atm and 110° C. for 15 min to obtain a reaction mixture, wherein the ultrasonic conditions were: 2000 W of ultrasonic power and 30 kHz of ultrasonic frequency; and
(2) after the treatment in step (1) was completed, performing solid-liquid separation on the reaction mixture, washing the solid part with water, and collecting and drying the solid part to obtain wheat straw pulp, with a pulping yield of 53%.

### EXAMPLE 5

The method for preparing a wheat straw pulp of the present Example included the following steps:
(1) adding 300 g of wheat straw to 1.2 L of water, followed by adding NaOH to the water until the mass concentration of NaOH was 1% to obtain a mixture, performing ultrasonic crushing treatment on the mixture at 25° C. for 5 min in an ultrasonic cell disruption device, wherein during the ultrasonic crushing treatment, 9 g of H₂O₂ was added to the water medium, then transferring the reaction system to a high-pressure reaction kettle for reaction at 1 atm and 100° C. for 15 min to obtain a reaction mixture, wherein the ultrasonic conditions were: 2000 W of ultrasonic power and 30 kHz of ultrasonic frequency; and
(2) after the treatment in step (1) was completed, performing solid-liquid separation on the reaction mixture, washing the solid part with water, and collecting and drying the solid part to obtain the wheat straw pulp, with a pulping yield of 57%.

### EXAMPLE 6

The method for preparing a wheat straw pulp of the present Example included the following steps:
(1) adding 300 g of wheat straw to 1.2 L of water, followed by adding NaOH to the water until the mass concentration of NaOH was 1% to obtain a mixture, performing ultrasonic crushing treatment on the mixture at 25° C. for 6 min in an ultrasonic cell disruption device, wherein during the ultrasonic crushing treatment, 12 g of H₂O₂ was added to the water medium, then transferring the reaction system to a high-pressure reaction kettle for reaction at 1 atm and 105° C. for 15 min to obtain a reaction mixture, wherein the ultrasonic conditions were: 2000 W of ultrasonic power and 30 kHz of ultrasonic frequency; and
(2) after the crushing treatment in step (1) was completed, performing solid-liquid separation on the reaction mixture, washing the solid part with water, and collecting and drying the solid part to obtain the wheat straw pulp, with a pulping yield of 54%.

### EXAMPLE 7

The method for preparing a wheat straw pulp of the present Example included the following steps:
(1) adding 300 g of wheat straw to 1.2 L of water, followed by adding NaOH to the water until the mass concentration of NaOH was 0.8% to obtain a mixture, and performing ultrasonic crushing treatment on the mixture at 100° C. for 8 min in an ultrasonic cell disruption device, wherein during the ultrasonic crushing treatment, 15 g of H₂O₂ was added to the water medium to obtain a reaction mixture, wherein the ultrasonic conditions were: 2000 W of ultrasonic power and 30 kHz of ultrasonic frequency; and
(2) after the crushing treatment in step (1) was completed, performing solid-liquid separation on the reaction mixture, washing the solid part with water, and collecting and drying the solid part to obtain the wheat straw pulp, with a pulping yield of 56%.

### EXAMPLE 8

The method for preparing a wheat straw pulp of the present Example included the following steps:
(1) adding 300 g of wheat straw to 1.2 L of water, followed by adding NaOH to the water until the mass concentration of NaOH was 0.8% to obtain a mixture, and performing ultrasonic crushing treatment on the mixture at 80° C. for 5 min in an ultrasonic cell disruption device, wherein during the ultrasonic crushing treatment, 9 g of H₂O₂ was added to the water medium to obtain a reaction mixture, wherein the ultrasonic conditions were: 2000 W of ultrasonic power and 30 kHz of ultrasonic frequency; and
(2) after the crushing treatment in step (1) was completed, performing solid-liquid separation on the reaction mixture, washing the solid part with water, and collecting and drying the solid part to obtain the wheat straw pulp, with a pulping yield of 60%.

### EXAMPLE 9

The method for preparing a wheat straw pulp of the present Example included the following steps:
(1) adding 300 g of wheat straw to 1.2 L of water, followed by adding NaOH to the water until the mass concentration of NaOH was 0.8% to obtain a mixture, and performing ultrasonic crushing treatment on the mixture at 90° C. for 6 min in an ultrasonic cell disruption device, wherein during the ultrasonic crushing treatment,12 g of H₂O₂ was added to the water medium to obtain a reaction mixture, wherein the ultrasonic conditions were: 2000 W of ultrasonic power and 30 kHz of ultrasonic frequency; and
(2) after the crushing treatment in step (1) was completed, performing solid-liquid separation on the reaction mixture, washing the solid part with water, and collecting and drying the solid part to obtain the wheat straw pulp, with a pulping yield of 58%.

### EXAMPLE 10

The method for preparing a wheat straw pulp of the present Example included the following steps:
(1) adding 300 g of wheat straw to 1.2 L of water, followed by adding NaOH to the water until the mass concentration of NaOH was 1% to obtain a mixture, and performing ultrasonic crushing treatment on the mixture at 100° C. for 8 min in an ultrasonic cell disruption device to obtain a reaction mixture, wherein the ultrasonic conditions were: 2000 W of ultrasonic power and 30 kHz of ultrasonic frequency; and
(2) after the crushing treatment in step (1) was completed, performing solid-liquid separation on the reaction mixture, washing the solid part with water, and collecting and drying the solid part to obtain the wheat straw pulp, with a pulping yield of 62%.

### EXAMPLE 11

The method for preparing a wheat straw pulp of the present Example included the following steps:
(1) adding 300 g of wheat straw to 1.2 L of water, followed by adding NaOH to the water until the mass concentration of NaOH was 1% to obtain a mixture, and performing ultrasonic crushing treatment on the mixture at 80° C. for 5 min in an ultrasonic cell disruption device to obtain a reaction mixture, wherein the ultrasonic conditions were: 2000 W of ultrasonic power and 30 kHz of ultrasonic frequency; and
(2) after the crushing treatment in step (1) was completed, performing solid-liquid separation on the reaction mixture, washing the solid part with water, and collecting and drying the solid part to obtain the wheat straw pulp, with a pulping yield of 66%.

### EXAMPLE 12

The method for preparing a wheat straw pulp of the present Example included the following steps:
(1) adding 300 g of wheat straw to 1.2 L of water, followed by adding NaOH to the water until the mass concentration of NaOH was 0.8% to obtain a mixture, and performing ultrasonic crushing treatment on the mixture at 80° C. for 8 min in an ultrasonic cell disruption device to obtain a reaction mixture, wherein the ultrasonic conditions were: 2000 W of ultrasonic power and 30 kHz of ultrasonic frequency; and
(2) after the crushing treatment in step (1) was completed, performing solid-liquid separation on the reaction mixture, washing the solid part with water, and collecting and drying the solid part to obtain the wheat straw pulp, with a pulping yield of 65%.

### EXAMPLE 13

The method for preparing a wheat straw pulp of the present Example included the following steps:
(1) adding 300 g of wheat straw to 1.2 L of water, followed by adding NaOH to the water until the mass concentration of NaOH was 0.8% to obtain a mixture, and performing ultrasonic crushing treatment on the mixture at 70° C. for 5 min in an ultrasonic cell disruption device to obtain a reaction mixture, wherein the ultrasonic conditions were: 2000 W of ultrasonic power and 30 kHz of ultrasonic frequency; and
(2) after the crushing treatment in step (1) was completed, performing solid-liquid separation on the reaction mixture, washing the solid part with water, and collecting and drying the solid part to obtain wheat straw pulp, with a pulping yield of 68%.

### EXAMPLE 14

The method for preparing a wheat straw pulp of the present Example included the following steps:
(1) adding 300 g of wheat straw to 1.2 L of water, followed by adding NaOH to the water until the mass concentration of NaOH is 0.5% to obtain a mixture, and performing ultrasonic crushing treatment on the mixture at 50° C. for 3 min in an ultrasonic cell disruption device to obtain a reaction mixture, wherein the ultrasonic conditions were: 2000 W of ultrasonic power and 30 kHz of ultrasonic frequency; and
(2) after the crushing treatment in step (1) was completed, performing solid-liquid separation on the reaction mixture, washing the solid part with water, and collecting and drying the solid part to obtain the wheat straw pulp, with a pulping yield of 70%.

### EXAMPLE 15

The wheat straw pulps prepared in Examples 1-14 were used as raw materials to prepare carboxymethyl cellulose products. The method for preparing carboxymethyl cellulose comprised the following steps:
adding 300 mg of each wheat straw pulp to 25 g of isopropanol to disperse uniformly, followed by adding 0.24 g of sodium hydroxide and 0.54 g of chloroacetic acid for a reaction under stirring at 55° C. for 8 h to obtain a reaction mixture, cooling the reaction mixture after the reaction was completed, performing solid-liquid separation, collecting the solids, washing the solids with a mixed solution of water and methanol (volume ratio of water and methanol is 1:9) for 3-5 times and then with methanol for 2-3 times, and drying the solids to obtain the carboxymethyl cellulose product.

### Experimental Example 1

In order to compare and illustrate the performances of the wheat straw pulps prepared under different conditions in the examples of the present disclosure, the whiteness of the wheat straw pulp obtained in each example was tested. For the test method, refer to GB 8940.2. The test results are shown in Table 1.

TABLE 1
Whiteness of Wheat Straw Pulps Obtained by Different Treatments

| No. | Whiteness (%) |
|---|---|
| Example 1 | 86 |
| Example 2 | 80 |
| Example 3 | 84 |
| Example 4 | 83 |
| Example 5 | 75 |
| Example 6 | 81 |
| Example 7 | 80 |
| Example 8 | 70 |
| Example 9 | 77 |
| Example 10 | 68 |
| Example 11 | 58 |
| Example 12 | 60 |
| Example 13 | 50 |
| Example 14 | 40 |

As can be seen from the above table, in the present disclosure, degrees of dissociation and delignification of wheat straw are controlled by adjusting conditions of the ultrasonic crushing treatment, including duration and temperature of the ultrasonic crushing treatment, adding of NaOH or not, adding of H₂O₂ or not, and amount of H₂O₂ if added, to obtain wheat straw pulps with various whiteness.

### Experimental Example 2

In order to further illustrate the effect of conditions of the ultrasonic crushing treatment of wheat straws on the substitution degree of carboxymethyl cellulose prepared, the substitution degrees of carboxymethyl cellulose products prepared in Example 15 using the wheat straw pulps of Examples 1-14 as raw materials, respectively, were tested, by an acidity meter titration method (Drilling and Completion Fluids, 14 (5), 35-36, 1997.) and a nuclear magnetic resonance method (NMR) method to determine the average substitution degree (Mokuzai Gakkashi, 31 (1), 14-19, 1985.). The test results are shown in Table 2.

TABLE 2
Substitution Degree of Carboxymethyl Cellulose
Products Obtained by Different Treatments

| No. | Average substitution degree |
|---|---|
| Example 1 | 1.67 |
| Example 2 | 1.18 |
| Example 3 | 1.49 |
| Example 4 | 1.23 |
| Example 5 | 0.88 |
| Example 6 | 1.09 |
| Example 7 | 1.02 |
| Example 8 | 0.90 |
| Example 9 | 0.97 |
| Example 10 | 0.98 |
| Example 11 | 0.76 |
| Example 12 | 0.79 |
| Example 13 | 0.68 |
| Example 14 | 0.52 |

As can be seen from the above table, by adjusting the process parameters (including the duration and temperature of ultrasonic treatment, whether NaOH and/or H₂O₂ are added, and the amount of the added H₂O₂) of preparation process of the wheat straw pulp, wheat straws are dissociated to different degrees and the degree of delignification is controlled. Therefore, carboxymethyl cellulose products with different substitution degrees are obtained, to meet the needs of application in different fields.

Finally, it should be noted that the above Examples are only used to illustrate the technical solutions of the present disclosure, but not limited thereto. Although the present disclosure has been described in detail with reference to the foregoing Examples, those skilled in the art should understand that: the technical solutions described in the foregoing Examples may still be modified, or some or all of the technical features therein may be equivalently replaced, and these modifications or replacements do not deviate the essence of the corresponding technical solutions from the technical solutions of the Examples of the disclosure scope.

### INDUSTRIAL APPLICABILITY

In the method for preparing a wheat straw pulp of the present disclosure, the ultrasonic crushing treatment is preformed using water as a medium, where small amounts of H₂O₂ and NaOH may be added to adjust pH, so as to adjust the degree of delignification, and thus to provide wheat straw pulps with various whiteness, which production process is environmentally friendly and low-cost. By using the wheat straw pulp of the present disclosure as a raw material to prepare carboxymethyl cellulose, carboxymethyl cellulose products with different substitution degrees can be obtained, so as to meet application requirements in different fields. By adjusting the process parameters (including the concentration of NaOH, the duration and temperature of ultrasonic treatment and the amount of the added H₂O₂) in the preparation process of the wheat straw pulp, wheat straws are dissociated to different degrees and the degree of delignification is controlled, so that carboxymethyl cellulose products with different substitution degrees in a range of 0.52-1.67 are obtained, and the substitution degree of carboxymethyl cellulose can be adjusted according to actual needs.

What is claimed is:

1. A method for preparing a wheat straw pulp, comprising following steps of:
making wheat straws subjected to an ultrasonic crushing treatment using water as a medium, followed by performing solid-liquid separation and collecting solids to obtain the wheat straw pulp, wherein the ultrasonic crushing treatment is performed at a temperature of 25-100° C.

2. The method for preparing a wheat straw pulp according to claim 1, wherein NaOH is added to the water for the ultrasonic crushing treatment of the wheat straws, and a mass fraction of NaOH in water is 0.1-1.5%.

3. The method for preparing a wheat straw pulp according to claim 1, wherein H₂O₂ is added to the medium during the ultrasonic crushing treatment, and a mass of the added H₂O₂ is 2-8% of a mass of the wheat straws.

4. The method for preparing a wheat straw pulp according to claim 1, wherein after the ultrasonic crushing treatment, the temperature is raised to 100-130° C. and then maintained for 10-15 min, and then the solid-liquid separation is performed, and the solids are collected to obtain the wheat straw pulp wherein, the ultrasonic crushing treatment is conducted for 2-10 min; and a mass ratio of the wheat straws to the water is 1:(3-6).

5. The method for preparing a wheat straw pulp according to claim 1, wherein the ultrasonic crushing treatment is conducted at the temperature of 50-70° C. for 3-5 min, and a mass fraction of NaOH in the medium is 0.5-0.8%; or
the ultrasonic crushing treatments conducted at the temperature of 70-80° C. for 5-8 min, and the mass fraction of NaOH in the medium is 0.8-1%; or
the ultrasonic crushing treatment is conducted at the temperature of 80-100° C. for 5-8 min, and the mass fraction of NaOH in the medium is 1-1.5%; or
the ultrasonic crushing treatment is conducted at the temperature of 80-100° C. for the mass fraction of NaOH in the medium is 0.8-1%, and a mass of the added H₂O₂ is 3-5% of a mass of the wheat straws; or
the ultrasonic crushing treatment is conducted at the temperature of 25-30° C. for 5-8 min, the mass fraction of NaOH in the medium is 1-1.5%, the mass of the added H₂O₂ is 3-5% of the mass of the wheat straws, and the temperature is raised after the ultrasonic crushing treatment to 100-110° C., and maintained for 10-15 min; or
the ultrasonic crushing treatments conducted at the temperature of 25-30° C. for 5-8 min, the mass fraction of NaOH in the medium is 1-1.5%, the mass of the added H₂O₂ is 5-7% of the mass of the wheat straws, the temperature is raised after the ultrasonic crushing treatment to 100-130° C., and maintained for 10-15 min.

6. The method for preparing a wheat straw pulp according to claim 1, wherein the ultrasonic crushing treatment is conducted under a condition: an ultrasonic power being 1100-3300 W, and an ultrasonic frequency being 20-40 kHz.

7. The method for preparing a wheat straw pulp according to claim 1, wherein the wheat straw pulp prepared by the method for preparing a wheat straw pulp has a whiteness of 40-86%.

8. A method for preparing carboxymethyl cellulose, comprising:
dispersing the wheat straw pulp prepared by method for preparing a wheat straw pulp according to claim 1 in isopropanol, adding sodium hydroxide and chloroacetic acid to obtain a mixture, stirring the mixture at a temperature of 50-60° C. for reaction for 4-12 h to obtain a reaction mixture, collecting solids from the reaction mixture, and washing and drying the solids to obtain the carboxymethyl cellulose.

9. The method for preparing carboxymethyl cellulose according to claim 8, wherein a mass ratio of the wheat straw pulp to isopropanol is 1:(30-120).

10. The method for preparing carboxymethyl cellulose according to claim 8, wherein different substitution degrees of the carboxymethyl celluloses are obtained by adjusting a concentration of NaOH in the medium, duration and temperature of the ultrasonic crushing treatment of the wheat straws, and a mass of the added H₂O₂,
wherein, a mass fraction of NaOH in the medium is 0.1-1.5%, the ultrasonic crushing treatment is conducted at the temperature of 25-100° C. for the duration of 2-10 min, and the mass of added H₂O₂ is 0-8% of a mass of the wheat straws,
when the wheat straw pulp used as a raw material is prepared under a condition that the ultrasonic crushing treatment is performed at the temperature of 50-70° C. for 3-5 min, a mass fraction of NaOH in the medium is 0.5-0.8%, and the mass of added H₂O₂ is 0, the carboxymethyl cellulose has a substitution degree of 0.52-0.68;
when the wheat straw pulp used as the a material is prepared under a condition that the ultrasonic crushing treatment is performed at the temperature of 70-80° C. for 5-8 min, the mass fraction of NaOH in the medium is 0.8-1%, and the mass of added H₂O₂ is 0, the carboxymethyl cellulose has the substitution degree of 0.68-0.79;
when the wheat straw pulp used as the raw material is prepared under a condition that the ultrasonic crushing treatment is performed at the temperature of 80-100° C. for 5-8 min, the mass fraction of NaOH in the medium is 1-1.5%, and the mass of added H₂O₂ is 0, the carboxymethyl cellulose has the substitution degree of 0.76-0.98;
when the wheat straw pulp used as the raw material is prepared under a condition that the ultrasonic crushing treatment is performed at the temperature of 80-100° C. for 5-8 min, the mass fraction of NaOH in the medium is 0.8-1 the mass of added H₂O₂ is 3-5% of the mass of the wheat straws, the carboxymethyl cellulose has the substitution degree of 0.90-1.02;
when the wheat straw pulp used as the raw material is prepared under a condition that the ultrasonic crushing treatment is performed at the temperature of 25-30° C. for 5-8 min, the mass fraction of NaOH in the medium is 1-1.5%, the mass of added H₂O₂ is 3-5% of the mass of the wheat straws, and the temperature is raised after the ultrasonic crushing treatment to 100-110° C. and maintained for 10-15 min, the carboxymethyl cellulose has the substitution degree of 0.88-1.23; and
when the wheat straw pulp used as the raw material is prepared under a condition that the ultrasonic crushing treatment is performed at the temperature of 25-30° C. for 5-8 min, the mass fraction of NaOH in the medium is 1-1.5%, the mass of added H₂O₂ is 5-7% of the mass of the wheat straws, and the temperature is raised after the ultrasonic crushing treatment to 100-130° C. and maintained for 10-15 min, the carboxymethyl cellulose has a substitution degree of 1.18-1.67.

11. A method for preparing carboxymethyl cellulose, comprising:
a) preparing a wheat straw pulp by the method for preparing a wheat straw pulp according to claim 1; and
b) making the wheat straw pulp in contact with a free base and an etherifying agent in a reaction medium

12. The method according to claim 11, wherein the free base is NaOH.

13. The method according to claim 11, wherein the etherifying agent is chloroacetic acid.

14. The method according to claim 11, wherein the reaction medium water or an organic solvent.

15. The method according to claim 14, wherein the organic solvent is at least one selected from the group consisting of ethanol, propanol, butanol and acetone.

16. The method according to claim 11, wherein the step b) is performed at 20-90° C., preferably 50-60° C.

17. The method according to claim 11, further comprising collecting solids, and washing and/or drying the solids.

18. The method according to claim 11, wherein a mass ratio of the wheat straw pulp to the reaction medium is 1:(30-120).

19. The method according to claim 11, wherein a mass ratio of the wheat straw pulp, the free base and the etherifying agent is 1:(0.5-1.2):(0.6-3).
